(19) United States
(12) Patent Application Publication
(10) Pub. No.: US 2026/0296425 A1
(43) Pub. Date: Oct. 1, 2026

(54) VEHICLE DRIVING ASSISTANCE APPARATUS, VEHICLE DRIVING ASSISTANCE METHOD, AND STORAGE MEDIUM STORING VEHICLE DRIVING ASSISTANCE PROGRAM

(71) Applicants: TOYOTA JIDOSHA KABUSHIKI KAISHA, Toyota-shi (JP); DENSO CORPORATION, Kariya-city (JP)

(72) Inventors: Hiroki TERASHITA, Susono-shi (JP); Hirotada OTAKE, Susono-shi (JP); Hideki KAMATANI, Toyota-shi (JP)

(73) Assignees: TOYOTA JIDOSHA KABUSHIKI KAISHA, Toyota-shi (JP); DENSO CORPORATION, Kariya-city (JP)

(21) Appl. No.: 19/634,168

(22) Filed: Mar. 31, 2026

(30) Foreign Application Priority Data
Apr. 1, 2025 (JP) 2025-060588

(51) Int. Cl. B60W 30/16; B60W 30/18; B60W 50/08; B60W 50/10; B60W 60/00

(52) U.S. Cl. CPC B60W 30/16; B60W 30/18072; B60W 50/085; B60W 50/10; B60W 60/001; B60W 2554/80

(57) ABSTRACT

A vehicle driving assistance apparatus executes an intermittent vehicle speed and inter-vehicle distance controls of autonomously causing a host vehicle to travel. The intermittent vehicle speed control causes the host vehicle to travel such that a host vehicle speed is maintained within a predetermined speed range when a preceding vehicle does not exist. The intermittent inter-vehicle distance control causes the host vehicle to travel such that an inter-vehicle distance is maintained within a predetermined distance range when the preceding vehicle exists. A driving assistance level for the host vehicle by the intermittent traveling control is set by an operator of the host vehicle. When the driving assistance level is set to a first level, the apparatus sets the predetermined speed range and the predetermined distance range to wider ranges as compared with when the driving assistance level is set to a second level lower than the first level.

### CROSS-REFERENCE TO RELATED APPLICATIONS

This application claims priority to Japanese patent application No. JP 2025-060588 filed on Apr. 1, 2025, the content of which is hereby incorporated by reference in its entirety.

### BACKGROUND

### Field

The present invention relates to a vehicle driving assistance apparatus, a vehicle driving assistance method, and a storage medium storing a vehicle driving assistance program.

### Description of the Related Art

There is known a vehicle driving assistance apparatus that executes, as an intermittent traveling control, an intermittent vehicle speed control of causing a host vehicle to travel by autonomously and alternately repeating a powering process of driving the host vehicle by a driving force and a coasting process of causing the host vehicle to coast such that a traveling speed of the host vehicle is maintained within a predetermined speed range (for example, see Japanese Unexamined Patent Application Publication No. 2017-094981). By executing the intermittent traveling control, it is possible to reduce a traveling energy consumption amount. It should be noted that the traveling energy consumption amount is an amount of energy consumed by a driving device of the host vehicle to generate a driving force for causing the vehicle to travel.

By the way, there is a vehicle driving assistance apparatus in which an operator of the host vehicle can set a driving assistance level by the intermittent traveling control. Here, when the driving assistance level is high, the operator of the host vehicle desires to largely reduce the traveling energy consumption amount. On the other hand, when the driving assistance level is low, the operator of the host vehicle does not desire to largely reduce the traveling energy consumption amount. Therefore, when the driving assistance level can be set by the operator of the host vehicle, it is desired that the intermittent traveling control be executed in accordance with the desire of the operator of the host vehicle for reduction of the traveling energy consumption amount.

### SUMMARY

An object of the present invention is to provide a vehicle driving assistance apparatus, a vehicle driving assistance method, and a computer-readable non-transitory storage medium storing a vehicle driving assistance program which can execute the intermittent traveling control in accordance with the desire of the operator of the host vehicle for reduction of the traveling energy consumption amount.

A vehicle driving assistance apparatus according to the present invention comprises an electronic control unit configured to execute an intermittent traveling control of autonomously causing a host vehicle to travel as a driving assistance control. The intermittent traveling control includes an intermittent vehicle speed control and an intermittent inter-vehicle distance control. The intermittent vehicle speed control is a control of causing the host vehicle to travel by autonomously and alternately repeating a powering control of driving the host vehicle by a driving force and a coasting control of causing the host vehicle to coast such that a traveling speed of the host vehicle is maintained within a predetermined speed range when a preceding vehicle does not exist. The intermittent inter-vehicle distance control is a control of causing the host vehicle to travel by autonomously and alternately repeating the powering control and the coasting control such that an inter-vehicle distance between the host vehicle and the preceding vehicle is maintained within a predetermined distance range when the preceding vehicle exists. A driving assistance level for the host vehicle by the intermittent traveling control is set by an operator of the host vehicle. The electronic control unit is configured to, when the driving assistance level is set to a first level, set the predetermined speed range and the predetermined distance range to wider ranges as compared with when the driving assistance level is set to a second level lower than the first level.

When the intermittent traveling control is executed, if the predetermined speed range is wide, a reduction effect of the traveling energy consumption amount by the intermittent traveling control tends to be large. Similarly, when the intermittent traveling control is executed, if the predetermined distance range is wide, the reduction effect of the traveling energy consumption amount by the intermittent traveling control tends to be large. On the other hand, when the driving assistance level is set to a high level, the operator of the host vehicle desires a large reduction effect of the traveling energy consumption amount.

According to the vehicle driving assistance apparatus of the present invention, when the driving assistance level is set to a high level (that is, the first level), the predetermined speed range and the predetermined distance range are set to wider ranges as compared with a when the driving assistance level is set to a low level (that is, the second level). Therefore, the intermittent traveling control can be executed in accordance with the desire of the operator of the vehicle for reduction of the traveling energy consumption amount.

It should be noted that, in the vehicle driving assistance apparatus according to an aspect of the present invention, the electronic control unit may be configured to limit an acceleration rate of the host vehicle within a range of not more than an upper limit acceleration rate and not less than a lower limit acceleration rate when the intermittent traveling control is executed. Further, the electronic control unit may be configured to, when the driving assistance level is set to the second level, set the upper limit acceleration rate to a smaller value and set the lower limit acceleration rate to a larger value as compared with when the driving assistance level is set to the first level.

When the driving assistance level is set to a low level, the operator of the host vehicle desires that the traveling speed of the host vehicle does not greatly change.

According to the vehicle driving assistance apparatus of this aspect of the present invention, when the driving assistance level is set to a low level (that is, the second level), the upper limit acceleration is set to a smaller value and the lower limit acceleration is set to a larger value as compared with when the driving assistance level is set to a high level (that is, the first level). For this reason, a large change in the traveling speed of the host vehicle is suppressed. Therefore, the intermittent traveling control can be executed in accordance with the desire of the operator of the host vehicle.

Further, a vehicle driving assistance method according to the present invention is a method of executing an intermittent traveling control of autonomously causing a host vehicle to travel as a driving assistance control. The intermittent traveling control includes an intermittent vehicle speed control and an intermittent inter-vehicle distance control. The intermittent vehicle speed control is a control of causing the host vehicle to travel by autonomously and alternately repeating a powering control of driving the host vehicle by a driving force and a coasting control of causing the host vehicle to coast such that a traveling speed of the host vehicle is maintained within a predetermined speed range when a preceding vehicle does not exist. The intermittent inter-vehicle distance control is a control of causing the host vehicle to travel by autonomously and alternately repeating the powering control and the coasting control such that an inter-vehicle distance between the host vehicle and the preceding vehicle is maintained within a predetermined distance range when the preceding vehicle exists. A driving assistance level for the host vehicle by the intermittent traveling control is set by an operator of the host vehicle. The vehicle driving assistance method comprises a step of, when the driving assistance level is set to a first level, setting the predetermined speed range and the predetermined distance range to wider ranges as compared with when the driving assistance level is set to a second level lower than the first level.

According to the vehicle driving assistance method of the present invention, for the same reasons as those described above, the intermittent traveling control can be executed in accordance with the desire of the operator of the host vehicle for reduction of the traveling energy consumption amount.

Furthermore, a computer-readable non-transitory storage medium stores a vehicle driving assistance program which executes an intermittent traveling control of autonomously causing a host vehicle to travel as a driving assistance control. The intermittent traveling control includes an intermittent vehicle speed control and an intermittent inter-vehicle distance control. The intermittent vehicle speed control is a control of causing the host vehicle to travel by autonomously and alternately repeating a powering control of driving the host vehicle by a driving force and a coasting control of causing the host vehicle to coast such that a traveling speed of the host vehicle is maintained within a predetermined speed range when a preceding vehicle does not exist. The intermittent inter-vehicle distance control is a control of causing the host vehicle to travel by autonomously and alternately repeating the powering control and the coasting control such that an inter-vehicle distance between the host vehicle and the preceding vehicle is maintained within a predetermined distance range when the preceding vehicle exists. A driving assistance level for the host vehicle by the intermittent traveling control is set by an operator of the host vehicle. The vehicle driving assistance program is configured to, when the driving assistance level is set to a first level, set the predetermined speed range and the predetermined distance range to wider ranges as compared with when the driving assistance level is set to a second level lower than the first level.

According to the vehicle driving assistance program of the present invention, for the same reasons as those described above, the intermittent traveling control can be executed in accordance with the desire of the operator of the host vehicle for reduction of the traveling energy consumption amount.

The constituent elements of the present invention are not limited to the embodiments of the present invention described below with reference to the drawings. Other objects, other features, and accompanying advantages of the present invention will be readily understood from the description of the embodiments of the present invention.

### BRIEF DESCRIPTION OF THE DRAWINGS

FIG. 1 is a diagram showing a vehicle driving assistance apparatus according to an embodiment of the present invention.

FIG. 2 is a diagram showing a situation in which a preceding vehicle exists.

FIG. 3 is a flowchart showing a routine executed by the vehicle driving assistance apparatus according to the embodiment of the present invention.

### DETAILED DESCRIPTION

Hereinafter, a vehicle driving assistance apparatus, a vehicle driving assistance method, and a computer-readable non-transitory storage medium storing a vehicle driving assistance program according to an embodiment of the present invention will be described with reference to the drawings.

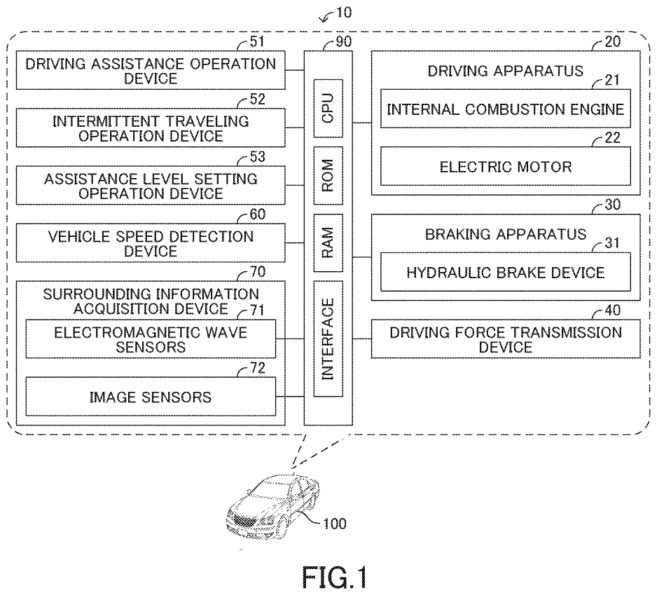

FIG. 1 shows a vehicle driving assistance apparatus 10 according to an embodiment of the present invention. The vehicle driving assistance apparatus 10 is mounted on a host vehicle 100. Hereinafter, the vehicle driving assistance apparatus 10 will be described by taking as an example a case where an operator or a user of the host vehicle 100 is a driver of the host vehicle 100 (that is, a person who rides in the host vehicle 100 and drives the host vehicle 100). However, the operator or the user of the host vehicle 100 may be a remote operator of the host vehicle 100 (that is, a person who remotely drives the host vehicle 100 without riding in the host vehicle 100). It should be noted that, in the following description, the driver of the host vehicle 100 may be simply referred to as a “driver”.

As shown in FIG. 1, the vehicle driving assistance apparatus 10 includes an ECU (electronic control unit) 90 as a control device. The ECU 90 includes a microcomputer as a main part. The microcomputer includes a CPU, a computer-readable storage medium, an interface, and the like. The storage medium is a ROM, a RAM, a non-volatile memory, and the like. The CPU is configured to implement various functions by executing instructions, a program, or a routine stored in the storage medium. In particular, in this example, the vehicle driving assistance apparatus 10 stores, in the storage medium, programs for implementing various controls executed by the vehicle driving assistance apparatus 10.

It should be noted that, in this example, the vehicle driving assistance apparatus 10 includes only one ECU 90. However, the vehicle driving assistance apparatus 10 may include a plurality of ECUs and may be configured such that the functions of the vehicle driving assistance apparatus 10 described below are shared by the ECUs, respectively.

Further, the vehicle driving assistance apparatus 10 may be configured to be able to update (upgrade) programs stored in the storage medium by wireless communication (for example, internet communication) with external devices.

Further, the vehicle driving assistance apparatus 10 may be applicable not only to a vehicle that travels by manual driving by an operator but also to a vehicle that travels by automatic driving.

As shown in FIG. 1, the host vehicle 100 is provided with a driving apparatus 20, a braking apparatus 30, and a driving force transmission device 40.

The driving apparatus 20 generates a driving force applied to the host vehicle 100 (in particular, driving wheels of the host vehicle 100). In this example, the driving apparatus 20 includes an internal combustion engine 21 and at least one electric motor 22. The driving apparatus 20 is electrically connected to the ECU 90. The vehicle driving assistance apparatus 10 controls the driving force applied to the host vehicle 100 by controlling operations of the driving apparatus 20 (that is, the internal combustion engine 21 and the electric motor 22).

The braking apparatus 30 applies a braking force to the host vehicle 100 (in particular, wheels of the host vehicle 100). In this example, the braking apparatus 30 includes a hydraulic brake device 31. The braking apparatus 30 is electrically connected to the ECU 90. The vehicle driving assistance apparatus 10 controls the braking force applied to the host vehicle 100 by controlling an operation of the braking apparatus 30 (more specifically, an operation of the hydraulic brake device 31).

The driving force transmission device 40 transmits a driving force output from the driving apparatus 20 to the driving wheels of the host vehicle 100. The driving force transmission device 40 is, for example, a transmission. The driving force transmission device 40 is electrically connected to the ECU 90.

The vehicle driving assistance apparatus 10 transmits the driving force output from the driving apparatus 20 to the driving wheels of the host vehicle 100 by controlling an operation of the driving force transmission device 40 to establish a driving force transmission path. The driving force transmission path is a path for transmitting the driving force from the driving apparatus 20 to the driving wheels of the host vehicle 100. On the other hand, the vehicle driving assistance apparatus 10 also prevents the driving force from being transmitted from the driving apparatus 20 to the driving wheels of the host vehicle 100 by controlling the operation of the driving force transmission device 40 to cut off the driving force transmission path.

Further, the host vehicle 100 is provided with a driving assistance operation device 51, an intermittent traveling operation device 52, an assistance level setting operation device 53, a vehicle speed detection device 60, and a surrounding information acquisition device 70.

The driving assistance operation device 51 is operated by the driver. The driver can request execution of a driving assistance control described below or can request stopping of the driving assistance control by operating the driving assistance operation device 51. The driving assistance operation device 51 is electrically connected to the ECU 90.

When the driving assistance operation device 51 is operated while the driving assistance control is not executed, the vehicle driving assistance apparatus 10 determines that execution of the driving assistance control is requested. On the other hand, when the driving assistance operation device 51 is operated while the driving assistance control is being executed, the vehicle driving assistance apparatus 10 determines that stopping of the driving assistance control is requested.

The intermittent traveling operation device 52 is also operated by the driver. The driver can request execution of an intermittent traveling control described below or can request stopping of the intermittent traveling control by operating the intermittent traveling operation device 52. The intermittent traveling operation device 52 is electrically connected to the ECU 90.

When the intermittent traveling operation device 52 is operated while execution of the driving assistance control is requested and the intermittent traveling control is not executed, the vehicle driving assistance apparatus 10 determines that execution of the intermittent traveling control is requested. On the other hand, when the intermittent traveling operation device 52 is operated while the intermittent traveling control is being executed, the vehicle driving assistance apparatus 10 determines that stopping of the intermittent traveling control is requested and that execution of a steady traveling control described below is requested.

The assistance level setting operation device 53 is also operated by the driver. The driver can set a driving assistance level L by operating the assistance level setting operation device 53.

In this example, as the driving assistance level L, three levels of a strong assistance level Ls, a medium assistance level Lm, and a weak assistance level Lw are prepared.

When the strong assistance level Ls is set as the driving assistance level L, a larger reduction in a traveling energy consumption amount is required as compared with when the medium assistance level Lm is set as the driving assistance level L.

Further, when the medium assistance level Lm is set as the driving assistance level L, a larger reduction in the traveling energy consumption amount is required as compared with when the weak assistance level Lw is set as the driving assistance level L.

In this manner, the driving assistance level L is a level representing a degree of reduction of the traveling energy consumption amount achieved by the intermittent traveling control. It should be noted that the traveling energy consumption amount is an amount of energy consumed by the driving apparatus 20 of the host vehicle 100 to generate a driving force for causing the host vehicle 100 to travel.

The assistance level setting operation device 53 is electrically connected to the ECU 90. The vehicle driving assistance apparatus 10 acquires the driving assistance level L set by an operation on the assistance level setting operation device 53. As described below, the vehicle driving assistance apparatus 10 changes control parameters of the intermittent traveling control in accordance with the set driving assistance level L.

In this manner, in this example, the driving assistance level L for the host vehicle 100 by the intermittent traveling control is set by the driver of the host vehicle 100.

The vehicle speed detection device 60 is used to detect a host vehicle speed V. The host vehicle speed V is a traveling speed of the host vehicle 100. The vehicle speed detection device 60 includes, for example, wheel rotation speed sensors provided at respective wheels of the host vehicle 100. The vehicle speed detection device 60 is electrically connected to the ECU 90. The vehicle driving assistance apparatus 10 acquires the host vehicle speed V by means of the vehicle speed detection device 60.

The surrounding information acquisition device 70 is used to detect information on surroundings of the host vehicle 100. In this example, the surrounding information acquisition device 70 includes a plurality of electromagnetic wave sensors 71 and a plurality of image sensors 72.

The electromagnetic wave sensors 71 are electrically connected to the ECU 90. The electromagnetic wave sensors 71 are, for example, radar sensors such as millimeter-wave radars. The vehicle driving assistance apparatus 10 acquires information (object information IO) on objects existing around the host vehicle 100 as surrounding information IS by means of the electromagnetic wave sensors 71. In particular, the object information IO includes information on a preceding vehicle 200.

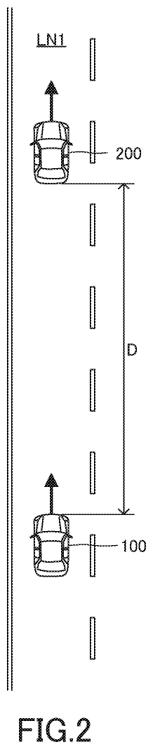

As shown in FIG. 2, the preceding vehicle 200 is another vehicle that travels in a host vehicle traveling lane LN1 and exists within a predetermined distance Dp ahead of the host vehicle 100. The host vehicle traveling lane LN1 is a lane in which the host vehicle 100 is traveling.

The image sensors 72 are electrically connected to the ECU 90. The image sensors 72 are, for example, camera sensors. The vehicle driving assistance apparatus 10 acquires image information IC on surroundings of the host vehicle 100 as surrounding information IS by means of the image sensors 72. In particular, the image information IC includes information on the preceding vehicle 200.

### Operation of Vehicle Driving Assistance Apparatus

Next, operation of the vehicle driving assistance apparatus 10 will be described.

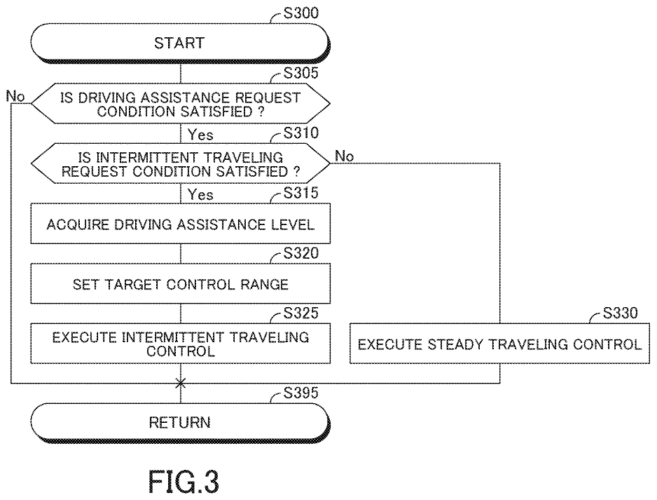

The vehicle driving assistance apparatus 10 executes a driving assistance control when predetermined conditions are satisfied by executing a routine shown in FIG. 3 at predetermined time intervals. The driving assistance control is a control of autonomously causing the host vehicle 100 to travel. The driving assistance control includes a steady traveling control and an intermittent traveling control.

The steady traveling control includes a steady vehicle speed control and a steady inter-vehicle distance control.

When the preceding vehicle 200 exists as shown in FIG. 2, the vehicle driving assistance apparatus 10 executes, as the steady traveling control, the steady inter-vehicle distance control. On the other hand, when the preceding vehicle 200 does not exist, the vehicle driving assistance apparatus 10 executes, as the steady traveling control, the steady vehicle speed control. The vehicle driving assistance apparatus 10 detects the preceding vehicle 200 based on the surrounding information IS.

The steady vehicle speed control is a control of autonomously causing the host vehicle 100 to travel by controlling operations of the driving apparatus 20 and the braking apparatus 30 such that the host vehicle speed V is maintained at a set vehicle speed Vset. The set vehicle speed Vset is set by the driver.

In this manner, the steady vehicle speed control is a control of causing the host vehicle 100 to travel by autonomously accelerating and decelerating the host vehicle 100 such that the host vehicle speed V is maintained at a predetermined speed (that is, the set vehicle speed Vset) when the preceding vehicle 200 does not exist.

On the other hand, the steady inter-vehicle distance control is a control of autonomously causing the host vehicle 100 to travel by controlling the operations of the driving apparatus 20 and the braking apparatus 30 such that an inter-vehicle distance D is maintained at a set inter-vehicle distance Dset. The inter-vehicle distance D is a distance between the host vehicle 100 and the preceding vehicle 200. The vehicle driving assistance apparatus 10 acquires the inter-vehicle distance D based on the surrounding information IS. The set inter-vehicle distance Dset is set by the driver.

In this manner, the steady inter-vehicle distance control is a control of causing the host vehicle 100 to travel by autonomously accelerating and decelerating the host vehicle 100 such that the inter-vehicle distance D is maintained at a predetermined inter-vehicle distance (that is, the set inter-vehicle distance Dset) when the preceding vehicle 200 exists.

Further, the intermittent traveling control includes an intermittent vehicle speed control and an intermittent inter-vehicle distance control.

The intermittent traveling control includes a powering control and a coasting control. The intermittent traveling control is a control of autonomously causing the host vehicle 100 to travel by alternately switching between and executing the powering control and the coasting control.

The powering control is a control of causing the host vehicle 100 to travel by the driving force. In particular, in this example, the powering control is a control of causing the host vehicle 100 to travel by the driving force such that the host vehicle 100 is accelerated. When the powering control is executed, the vehicle driving assistance apparatus 10 causes the host vehicle 100 to travel by applying the driving force to the host vehicle 100 from the driving apparatus 20. It should be noted that an optimum powering control may be adopted as the powering control. The optimum powering control is a control of causing the host vehicle 100 to travel by applying the driving force to the host vehicle 100 from the driving apparatus 20 while controlling an operation of the driving apparatus 20 such that driving energy efficiency becomes the highest. It should be noted that the driving energy efficiency is energy efficiency when the driving apparatus 20 generates a driving force.

The coasting control is a control of causing the host vehicle 100 to coast. When the coasting control is executed, the vehicle driving assistance apparatus 10 causes the host vehicle 100 to coast by stopping application of the driving force from the driving apparatus 20 to the host vehicle 100. In this example, when the coasting control is executed, the vehicle driving assistance apparatus 10 stops application of the driving force from the driving apparatus 20 to the host vehicle 100 by cutting off the driving force transmission path. As described above, the driving force transmission path is a path for applying the driving force from the driving apparatus 20 to the host vehicle 100. The vehicle driving assistance apparatus 10 cuts off the driving force transmission path by controlling the operation of the driving force transmission device 40. It should be noted that, in this example, when the coasting control is executed, an operation of the internal combustion engine 21 is stopped.

When the preceding vehicle 200 exists as shown in FIG. 2, the vehicle driving assistance apparatus 10 executes an intermittent inter-vehicle distance control as the intermittent traveling control. On the other hand, when the preceding vehicle 200 does not exist, the vehicle driving assistance apparatus 10 executes an intermittent vehicle speed control as the intermittent traveling control.

The intermittent vehicle speed control is a control of autonomously causing the host vehicle 100 to travel by alternately and repeatedly executing the powering control and the coasting control such that the host vehicle speed V is maintained at a speed within a target vehicle speed range RVtgt. Therefore, when the intermittent vehicle speed control is executed, the vehicle driving assistance apparatus 10 alternately switches between and executes the powering control and the coasting control such that the host vehicle speed V is maintained within a predetermined range (that is, the target vehicle speed range RVtgt).

While the intermittent vehicle speed control is executed, when the host vehicle speed V increases and reaches an upper limit speed Vmax due to execution of the powering control, the vehicle driving assistance apparatus 10 ends the powering control and starts the coasting control. The upper limit speed Vmax is an upper limit value of the target vehicle speed range RVtgt. In this example, the set vehicle speed Vset is set as the upper limit speed Vmax (Vmax=Vset).

On the other hand, while the intermittent vehicle speed control is executed, when the host vehicle speed V decreases and reaches a lower limit speed Vmin due to execution of the coasting control, the vehicle driving assistance apparatus 10 ends the coasting control and starts the powering control. The lower limit speed Vmin is a lower limit value of the target vehicle speed range RVtgt. In this example, the lower limit speed Vmin is a value obtained by subtracting a target vehicle speed control width WVtgt from the set vehicle speed Vset (Vmin=Vset−WVtgt).

In this manner, the intermittent vehicle speed control is a control of causing the host vehicle 100 to travel by autonomously and alternately repeatedly executing the powering control and the coasting control such that the host vehicle speed V is maintained within a predetermined speed range (that is, the target vehicle speed range RVtgt) when the preceding vehicle 200 does not exist.

Further, the intermittent inter-vehicle distance control is a control of autonomously causing the host vehicle 100 to travel by autonomously and alternately repeatedly executing the powering control and the coasting control such that the inter-vehicle distance D is maintained at a distance within a target inter-vehicle distance range RDtgt. Therefore, when the intermittent inter-vehicle distance control is executed, the vehicle driving assistance apparatus 10 alternately switches between and executes the powering control and the coasting control such that the inter-vehicle distance D is maintained within a predetermined range (that is, the target inter-vehicle distance range RDtgt).

While the intermittent inter-vehicle distance control is executed, when the inter-vehicle distance D decreases and reaches a lower limit inter-vehicle distance Dmin due to execution of the powering control, the vehicle driving assistance apparatus 10 ends the powering control and starts the coasting control. The lower limit inter-vehicle distance Dmin is a lower limit value of the target inter-vehicle distance range RDtgt. In this example, the set inter-vehicle distance Dset is set as the lower limit inter-vehicle distance Dmin (Dmin=Dset).

On the other hand, while the intermittent inter-vehicle distance control is executed, when the inter-vehicle distance D increases and reaches an upper limit inter-vehicle distance Dmax due to execution of the coasting control, the vehicle driving assistance apparatus 10 ends the coasting control and starts the powering control. The upper limit inter-vehicle distance Dmax is an upper limit value of the target inter-vehicle distance range RDtgt. In this example, the upper limit inter-vehicle distance Dmax is a value obtained by adding a target inter-vehicle distance control width WDtgt to the lower limit inter-vehicle distance Dmin (Dmax=Dmin+WDtgt).

In this manner, the intermittent inter-vehicle distance control is a control of causing the host vehicle 100 to travel by autonomously and alternately repeatedly executing the powering control and the coasting control such that the inter-vehicle distance D is maintained within a predetermined distance range (that is, the target inter-vehicle distance range RDtgt) when the preceding vehicle 200 exists.

It should be noted that, when the powering control is executed, if the host vehicle speed V reaches the upper limit speed Vmax before the inter-vehicle distance D reaches the lower limit inter-vehicle distance Dmin, the vehicle driving assistance apparatus 10 stops the powering control and executes an upper limit vehicle speed maintaining control of controlling acceleration and deceleration of the host vehicle 100 such that the host vehicle speed V is maintained at the upper limit speed Vmax.

At a predetermined timing, the vehicle driving assistance apparatus 10 starts processing from a step S300 of the routine shown in FIG. 3. Then, the vehicle driving assistance apparatus 10 proceeds with the process to a step S305 to determine whether or not a driving assistance request condition C1 is satisfied. The driving assistance request condition C1 is satisfied when execution of driving assistance control is requested. On the other hand, the driving assistance request condition C1 becomes unsatisfied when stopping of the driving assistance control is requested.

When the driving assistance request condition C1 is not satisfied, the vehicle driving assistance apparatus 10 determines “No” at the step S305 and proceeds with the process directly to a step S395 to terminate the process of this routine once. On the other hand, when the driving assistance request condition C1 is satisfied, the vehicle driving assistance apparatus 10 determines “Yes” at the step S305 and proceeds with the process to a step S310 to determine whether or not an intermittent traveling request condition C2 is satisfied. The intermittent traveling request condition C2 is satisfied when execution of the intermittent traveling control is requested. On the other hand, the intermittent traveling request condition C2 becomes unsatisfied when stopping of the intermittent traveling control is requested.

When the intermittent traveling request condition C2 is not satisfied, the vehicle driving assistance apparatus 10 determines “No” at the step S310 and proceeds with the process to a step S340 to execute the steady traveling control. In this case, when the preceding vehicle 200 exists, the vehicle driving assistance apparatus 10 executes the steady inter-vehicle distance control as the steady traveling control. On the other hand, when the preceding vehicle 200 does not exist, the vehicle driving assistance apparatus 10 executes the steady vehicle speed control as the steady traveling control.

Next, the vehicle driving assistance apparatus 10 proceeds with the process to the step S395 to terminate the process of this routine once.

On the other hand, when the intermittent traveling request condition C2 is satisfied, the vehicle driving assistance apparatus 10 determines “Yes” at the step S310 and proceeds with the process to a step S315 to acquire the driving assistance level L.

Next, the vehicle driving assistance apparatus 10 proceeds with the process to a step S320 to set a target control range Rtgt.

Specifically, when the driver operates the assistance level setting operation device 53 to set the driving assistance level L to the strong assistance level Ls, the vehicle driving assistance apparatus 10 sets the target vehicle speed control width WVtgt and the target inter-vehicle distance control width WDtgt to an expanded vehicle speed control width WVl and an expanded inter-vehicle distance control width WDl, respectively. Accordingly, the lower limit speed Vmin and the upper limit inter-vehicle distance Dmax are set to a low speed Vl and a long inter-vehicle distance Dl, respectively.

On the other hand, when the driver operates the assistance level setting operation device 53 to set the driving assistance level L to the medium assistance level Lm, the vehicle driving assistance apparatus 10 sets the target vehicle speed control width WVtgt and the target inter-vehicle distance control width WDtgt to a standard vehicle speed control width WVb and a standard inter-vehicle distance control width WDb, respectively. Accordingly, the lower limit speed Vmin and the upper limit inter-vehicle distance Dmax are set to a standard speed Vb and a standard inter-vehicle distance Db, respectively.

Further, when the driver operates the assistance level setting operation device 53 to set the driving assistance level L to the weak assistance level Lw, the vehicle driving assistance apparatus 10 sets the target vehicle speed control width WVtgt and the target inter-vehicle distance control width WDtgt to a reduced vehicle speed control width WVs and a reduced inter-vehicle distance control width WDs, respectively. Accordingly, the lower limit speed Vmin and the upper limit inter-vehicle distance Dmax are set to a high speed Vh and a short inter-vehicle distance Ds, respectively.

Here, the low speed Vl is lower than the standard speed Vb. Further, the high speed Vh is higher than the standard speed Vb. Further, the long inter-vehicle distance Dl is longer than the standard inter-vehicle distance Db. Further, the short inter-vehicle distance Ds is shorter than the standard inter-vehicle distance Db.

Accordingly, the target vehicle speed range RVtgt is set to a wider range when the strong assistance level Ls is set as the driving assistance level L, as compared with when the medium assistance level Lm is set as the driving assistance level L. Further, the target vehicle speed range RVtgt is set to a wider range when the medium assistance level Lm is set as the driving assistance level L, as compared with when the weak assistance level Lw is set as the driving assistance level L.

Similarly, the target inter-vehicle distance range RDtgt is set to a wider range when the strong assistance level Ls is set as the driving assistance level L, as compared with when the medium assistance level Lm is set as the driving assistance level L. Further, the target inter-vehicle distance range RDtgt is set to a wider range when the medium assistance level Lm is set as the driving assistance level L, as compared with when the weak assistance level Lw is set as the driving assistance level L.

In this manner, when the driving assistance level L is set to a first level (for example, the strong assistance level Ls), the vehicle driving assistance apparatus 10 sets a predetermined speed range (that is, the target vehicle speed range RVtgt) and a predetermined distance range (that is, the target inter-vehicle distance range RDtgt) to wider ranges as compared with when the driving assistance level L is set to a second level (for example, the medium assistance level Lm or the weak assistance level Lw) lower than the first level.

Next, the vehicle driving assistance apparatus 10 proceeds with the process to a step S325 to execute the intermittent traveling control. In this case, when the preceding vehicle 200 exists, the vehicle driving assistance apparatus 10 executes the intermittent inter-vehicle distance control as the intermittent traveling control. On the other hand, when the preceding vehicle 200 does not exist, the vehicle driving assistance apparatus 10 executes the intermittent vehicle speed control as the intermittent traveling control.

Next, the vehicle driving assistance apparatus 10 proceeds with the process to the step S395 to terminate the process of this routine once.

The above is operation of the vehicle driving assistance apparatus 10.

When the intermittent traveling control is executed, if the target vehicle speed range RVtgt is wide, a reduction effect of the traveling energy consumption amount by the intermittent traveling control tends to be large. Similarly, when the intermittent traveling control is executed, if the target inter-vehicle distance range RDtgt is wide, the reduction effect of the traveling energy consumption amount by the intermittent traveling control tends to be large. Further, when the driving assistance level L is set to a high level, the driver of the host vehicle 100 desires a large reduction effect of the traveling energy consumption amount.

According to the vehicle driving assistance apparatus 10, when the driving assistance level L is set to a high level (for example, the strong assistance level Ls), the target vehicle speed range RVtgt and the target inter-vehicle distance range RDtgt are set to wider ranges as compared with when the driving assistance level L is set to a low level (for example, the medium assistance level Lm or the weak assistance level Lw). Therefore, the intermittent traveling control can be executed in accordance with the desire of the driver of the host vehicle 100 for reduction of the traveling energy consumption amount.

It should be noted that the present invention is not limited to the above embodiment, and various modifications can be adopted within the scope of the present invention.

For example, there exists an appropriate acceleration rate of the host vehicle 100 in accordance with a gradient of a road on which the host vehicle 100 is traveling. Therefore, the vehicle driving assistance apparatus 10 may be configured to set a target acceleration rate ARtgt and execute the intermittent traveling control such that an acceleration rate of the host vehicle 100 is maintained at the target acceleration rate ARtgt. In this case, for example, the vehicle driving assistance apparatus 10 sets, as the target acceleration rate ARtgt, an appropriate acceleration rate in accordance with the gradient of the road on which the host vehicle 100 is traveling.

In particular, there exists an appropriate acceleration rate of the host vehicle 100 in accordance with the gradient of the road on which the host vehicle 100 is traveling also from a viewpoint of reducing the traveling energy consumption amount as much as possible. Therefore, the vehicle driving assistance apparatus 10 may be configured to set the target acceleration rate ARtgt and execute the powering control such that the acceleration rate of the host vehicle 100 is maintained at the target acceleration rate ARtgt. Also in this case, for example, the vehicle driving assistance apparatus 10 sets, as the target acceleration rate ARtgt, an appropriate acceleration in accordance with the gradient of the road on which the host vehicle 100 is traveling.

Further, the vehicle driving assistance apparatus 10 may be configured to limit the target acceleration rate ARtgt to be not more than an upper limit acceleration rate ARU and to limit the target acceleration rate ARtgt to be not less than a lower limit acceleration rate ARL when the intermittent traveling control is executed. That is, the vehicle driving assistance apparatus 10 may be configured to limit the acceleration rate of the host vehicle 100 within a range of not more than the upper limit acceleration rate ARU and not less than the lower limit acceleration rate ARL when the intermittent traveling control is executed.

In this case, when the target acceleration rate ARtgt is greater than the upper limit acceleration rate ARU, the vehicle driving assistance apparatus 10 sets the upper limit acceleration rate ARU as the target acceleration rate ARtgt. On the other hand, when the target acceleration rate ARtgt is less than the lower limit acceleration rate ARL, the vehicle driving assistance apparatus 10 sets the lower limit acceleration rate ARL as the target acceleration rate ARtgt. Accordingly, it is possible to suppress the acceleration rate of the host vehicle 100 from becoming excessively large or from becoming excessively small.

Further, in addition to setting the target control range Rtgt at the step S320, the vehicle driving assistance apparatus 10 may be configured to set the upper limit acceleration rate ARU and the lower limit acceleration rate ARL in accordance with the driving assistance level L.

In this case, when the driver operates the assistance level setting operation device 53 to set the driving assistance level L to the strong assistance level Ls, the vehicle driving assistance apparatus 10 sets an expanded upper limit acceleration rate ARUl and an expanded lower limit acceleration rate ARLl as the upper limit acceleration rate ARU and the lower limit acceleration rate ARL, respectively. The expanded upper limit acceleration rate ARUl is set to a value greater than a standard upper limit acceleration rate ARUb. Further, the expanded lower limit acceleration rate ARLl is set to a value smaller than a standard lower limit acceleration rate ARLb.

Further, when the driver operates the assistance level setting operation device 53 to set the driving assistance level L to the medium assistance level Lm, the vehicle driving assistance apparatus 10 sets the standard upper limit acceleration rate ARUb and the standard lower limit acceleration rate ARLb as the upper limit acceleration rate ARU and the lower limit acceleration rate ARL, respectively.

Further, when the driver operates the assistance level setting operation device 53 to set the driving assistance level L to the weak assistance level Lw, the vehicle driving assistance apparatus 10 sets a reduced upper limit acceleration rate ARUs and a reduced lower limit acceleration rate ARLs as the upper limit acceleration rate ARU and the lower limit acceleration rate ARL, respectively. The reduced upper limit acceleration rate ARUs is set to a value smaller than the standard upper limit acceleration rate ARUb. Further, the reduced lower limit acceleration rate ARLs is set to a value greater than the standard lower limit acceleration rate ARLb.

That is, when the driving assistance level L is set to a second level (for example, the weak assistance level Lw), the vehicle driving assistance apparatus 10 may be configured to set the upper limit acceleration rate ARU to a smaller value and set the lower limit acceleration rate ARL to a larger value as compared with when the driving assistance level L is set to a first level (for example, the medium assistance level Lm or the strong assistance level Ls).

When the driving assistance level L is set to a low level, the driver of the host vehicle 100 desires that the host vehicle speed V does not greatly change.

According to the vehicle driving assistance apparatus 10, when the driving assistance level L is set to a low level (for example, the weak assistance level Lw), the upper limit acceleration rate ARU is set to a smaller value and the lower limit acceleration rate ARL is set to a larger value as compared with when the driving assistance level L is set to a high level (for example, the medium assistance level Lm or the strong assistance level Ls). For this reason, a large change in the host vehicle speed V is suppressed. Therefore, the intermittent traveling control can be executed in accordance with the desire of the driver of the host vehicle 100.

What is claimed is:

1. A vehicle driving assistance apparatus comprising an electronic control unit configured to execute an intermittent traveling control of autonomously causing a host vehicle to travel as a driving assistance control,
the intermittent traveling control including an intermittent vehicle speed control and an intermittent inter-vehicle distance control,
the intermittent vehicle speed control being a control of causing the host vehicle to travel by autonomously and alternately repeating a powering control of driving the host vehicle by a driving force and a coasting control of causing the host vehicle to coast such that a traveling speed of the host vehicle is maintained within a predetermined speed range when a preceding vehicle does not exist,
the intermittent inter-vehicle distance control being a control of causing the host vehicle to travel by autonomously and alternately repeating the powering control and the coasting control such that an inter-vehicle distance between the host vehicle and the preceding vehicle is maintained within a predetermined distance range when the preceding vehicle exists, and
a driving assistance level for the host vehicle by the intermittent traveling control being set by an operator of the host vehicle,
wherein the electronic control unit is configured to, when the driving assistance level is set to a first level, set the predetermined speed range and the predetermined distance range to wider ranges as compared with when the driving assistance level is set to a second level lower than the first level.

2. The vehicle driving assistance apparatus according to claim 1,
wherein the electronic control unit is configured to limit an acceleration rate of the host vehicle within a range of not more than an upper limit acceleration rate and not less than a lower limit acceleration rate when the intermittent traveling control is executed, and
wherein the electronic control unit is configured to, when the driving assistance level is set to the second level, set the upper limit acceleration rate to a smaller value and set the lower limit acceleration rate to a larger value as compared with when the driving assistance level is set to the first level.

3. A vehicle driving assistance method of executing an intermittent traveling control of autonomously causing a host vehicle to travel as a driving assistance control,
the intermittent traveling control including an intermittent vehicle speed control and an intermittent inter-vehicle distance control,
the intermittent vehicle speed control being a control of causing the host vehicle to travel by autonomously and alternately repeating a powering control of driving the host vehicle by a driving force and a coasting control of causing the host vehicle to coast such that a traveling speed of the host vehicle is maintained within a predetermined speed range when a preceding vehicle does not exist,
the intermittent inter-vehicle distance control being a control of causing the host vehicle to travel by autonomously and alternately repeating the powering control and the coasting control such that an inter-vehicle distance between the host vehicle and the preceding vehicle is maintained within a predetermined distance range when the preceding vehicle exists, and
a driving assistance level for the host vehicle by the intermittent traveling control being set by an operator of the host vehicle,
wherein the vehicle driving assistance method comprises a step of, when the driving assistance level is set to a first level, setting the predetermined speed range and the predetermined distance range to wider ranges as compared with when the driving assistance level is set to a second level lower than the first level.

4. A computer-readable non-transitory storage medium storing a vehicle driving assistance program which executes an intermittent traveling control of autonomously causing a host vehicle to travel as a driving assistance control,
the intermittent traveling control including an intermittent vehicle speed control and an intermittent inter-vehicle distance control,
the intermittent vehicle speed control being a control of causing the host vehicle to travel by autonomously and alternately repeating a powering control of driving the host vehicle by a driving force and a coasting control of causing the host vehicle to coast such that a traveling speed of the host vehicle is maintained within a predetermined speed range when a preceding vehicle does not exist,
the intermittent inter-vehicle distance control being a control of causing the host vehicle to travel by autonomously and alternately repeating the powering control and the coasting control such that an inter-vehicle distance between the host vehicle and the preceding vehicle is maintained within a predetermined distance range when the preceding vehicle exists, and
a driving assistance level for the host vehicle by the intermittent traveling control being set by an operator of the host vehicle,
wherein the vehicle driving assistance program is configured to, when the driving assistance level is set to a first level, set the predetermined speed range and the predetermined distance range to wider ranges as compared with when the driving assistance level is set to a second level lower than the first level.
